(19) United States
(12) Patent Application Publication
(10) Pub. No.: US 2003/0130859 A1
(43) Pub. Date: Jul. 10, 2003

(54) Method, process and apparatus to identify, define and qualify applied technologies for busines and government operations rules for the purpose of modeling and conducting project feasibilities and risk assessments

(76) Inventor: Michael B. Kennedy, Redding, CT (US)

Correspondence Address: Mr. Michael B. Kennedy, 70 Danbury Road, Wilton, CT, 06897, US

(21) Appl. No.: 10/041,976

(22) Filed: Jan. 9, 2002

(51) Int. Cl. G06F 17/60

(52) U.S. Cl. 705/1; 705/7

(57) ABSTRACT

This invention creates a structure, relative to the user's core competencies, for professional researchers of available technology projects, to systematically identify, qualify and assess the feasibility and risk involved with the design, planning, implementation, operations and management of a project type that is modeled using the method, process and apparatus detailed in the description of the invention. No other method, process or apparatus models or creates core-competency relations of the values that are outputted from the invention.

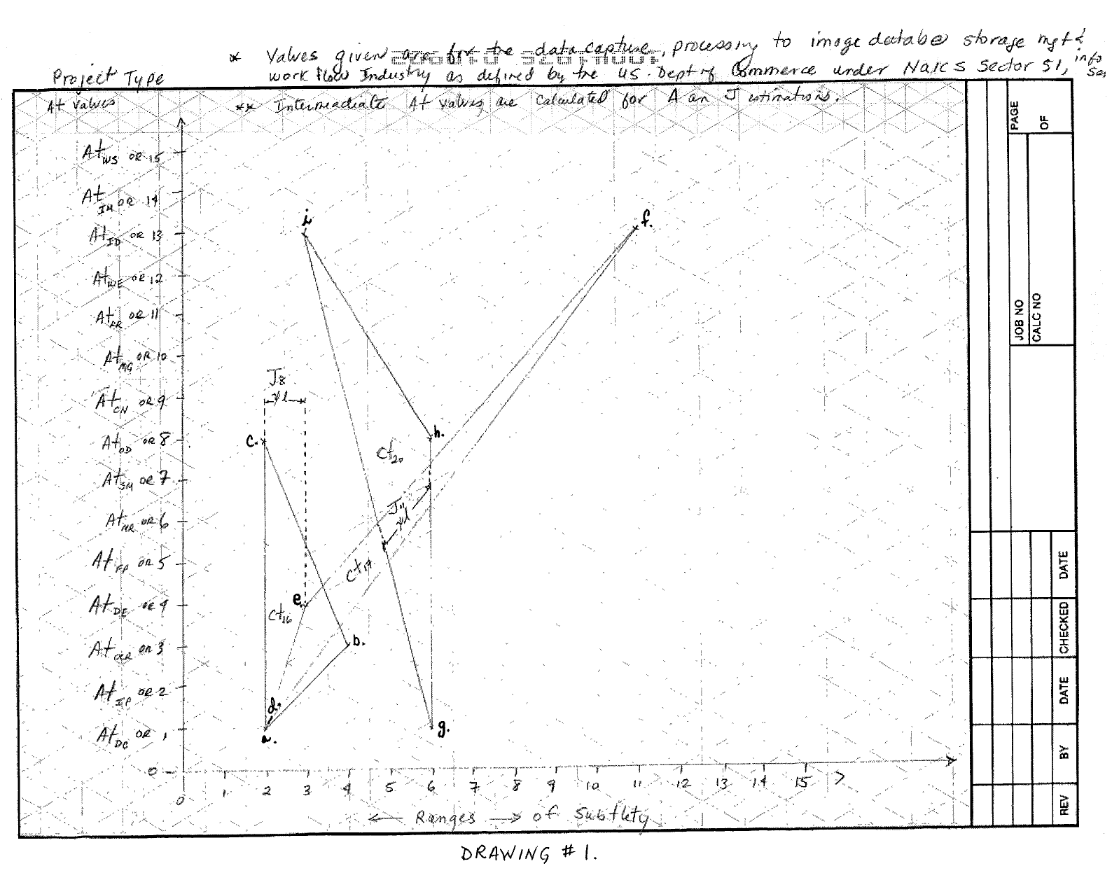

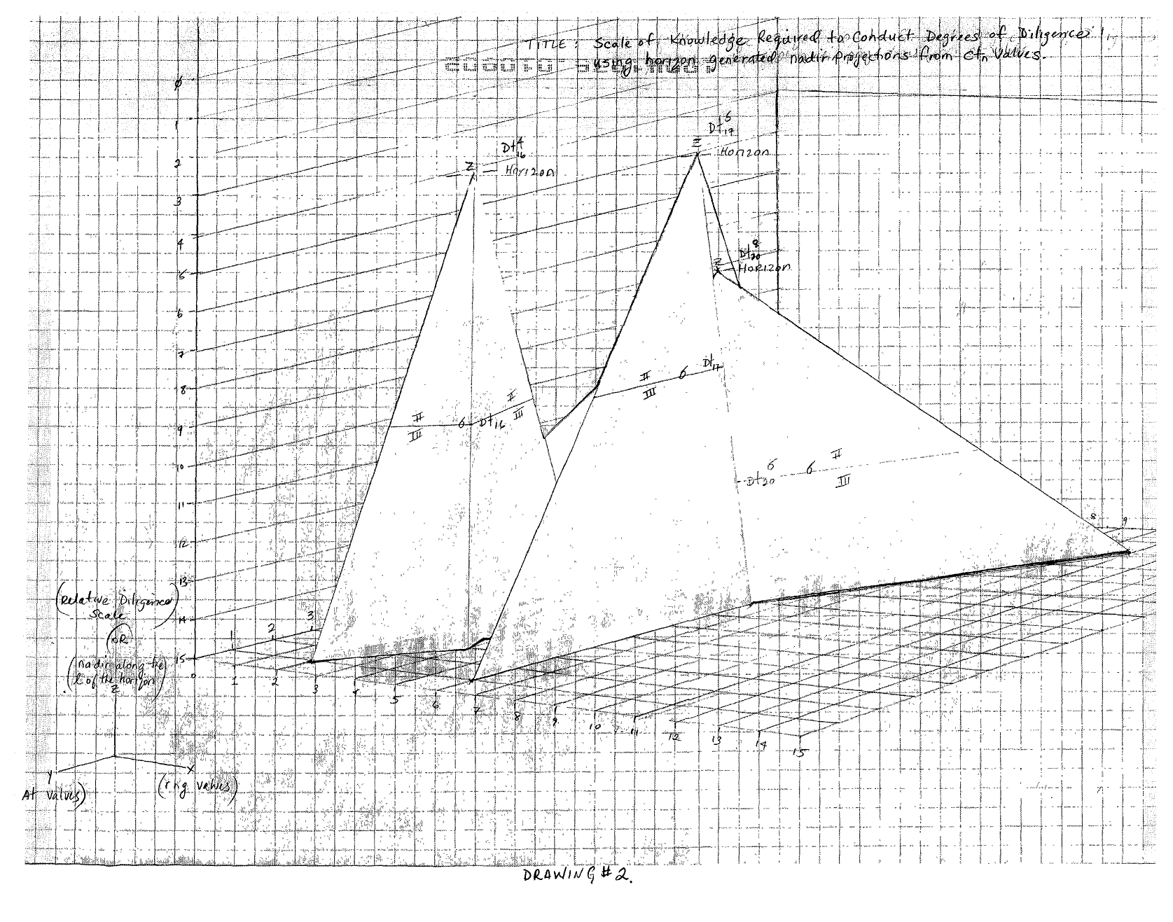

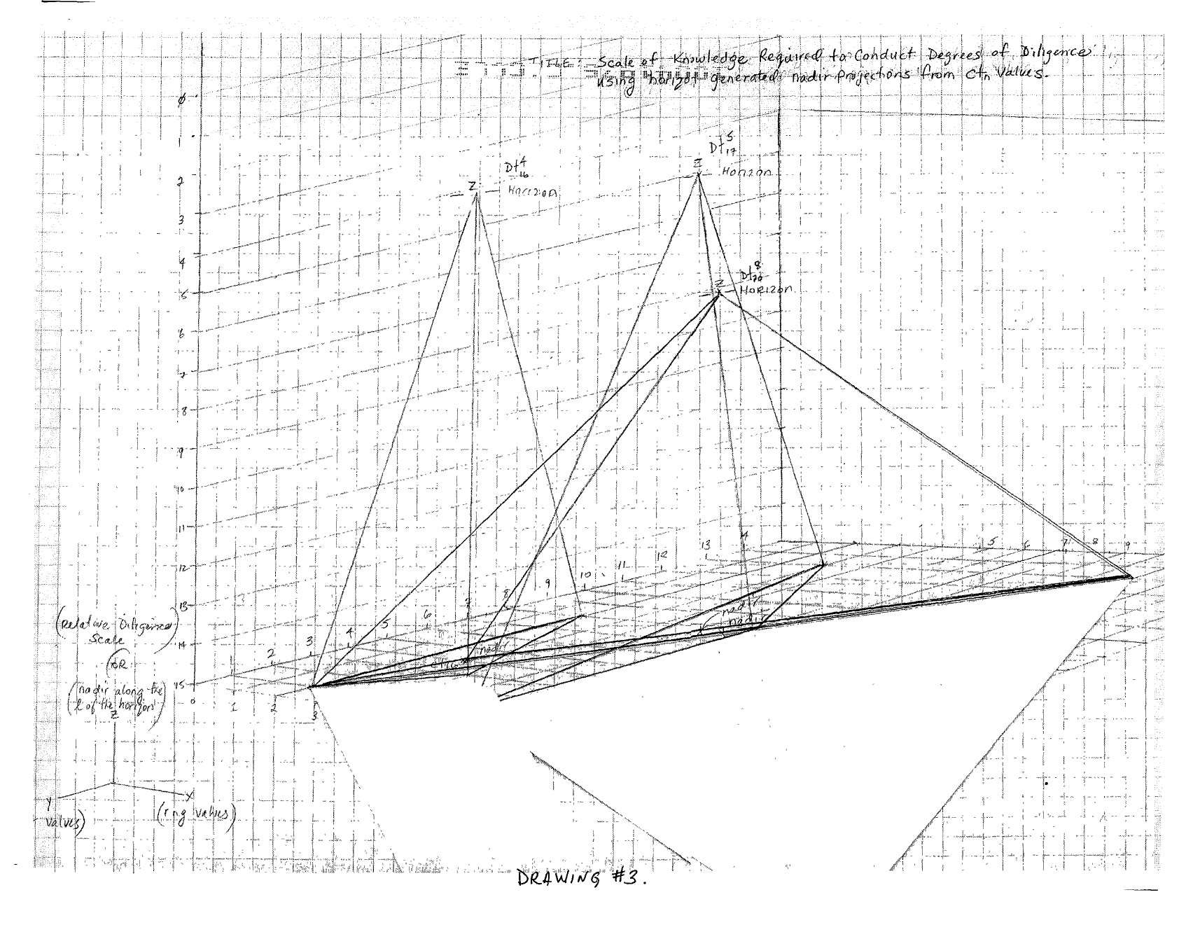

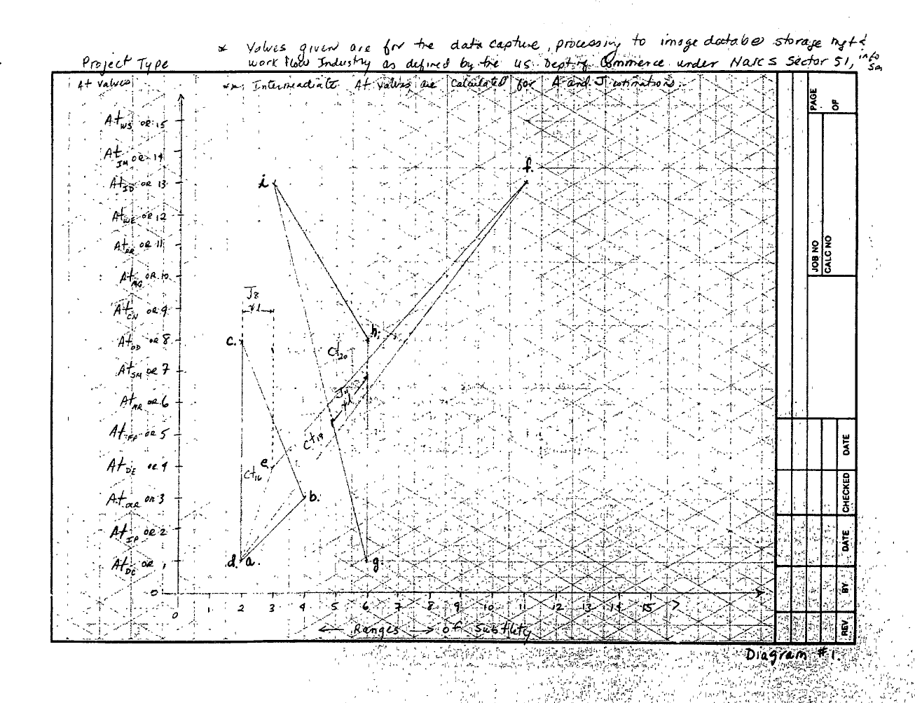

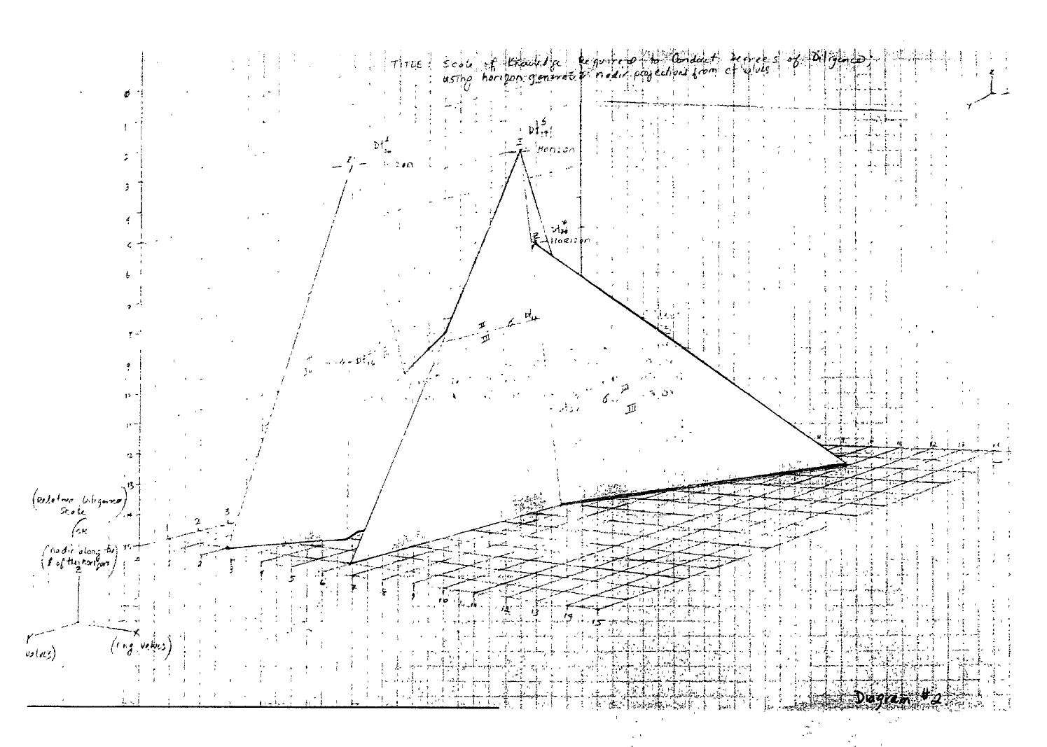

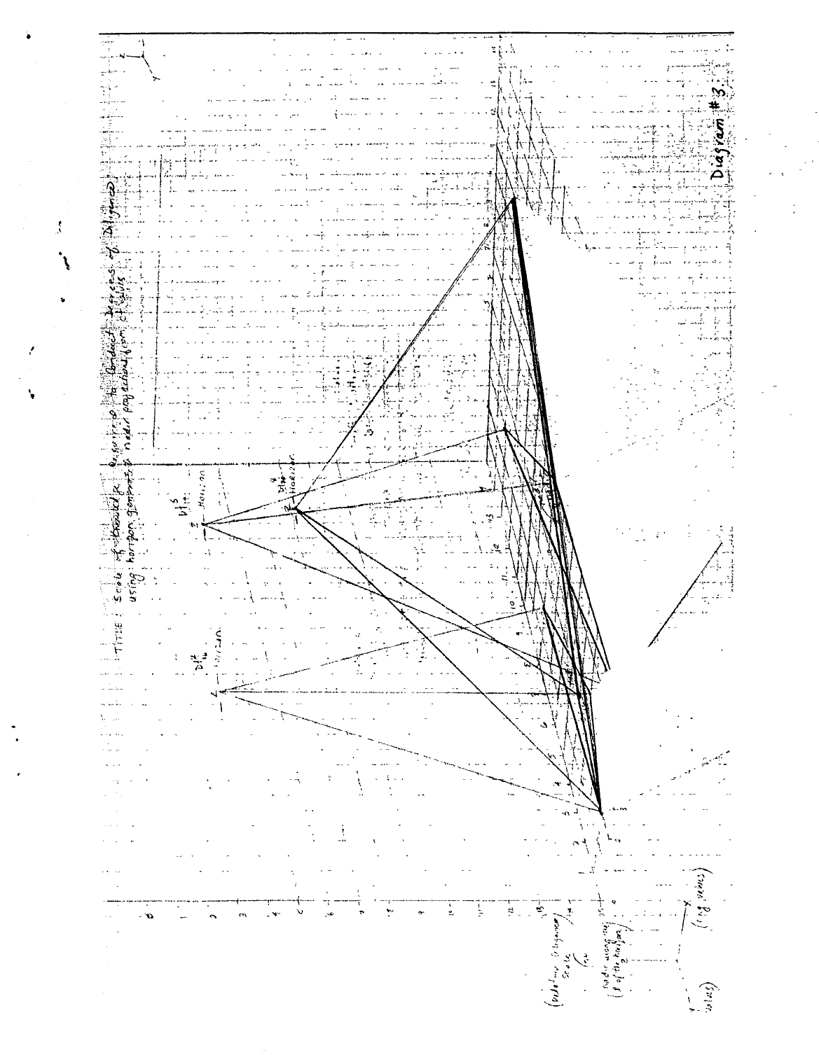

### CROSS-REFERENCE TO RELATED APPLICATIONS

The applicant claims the benefit of the provisional application of this invention, which was made on Dec. 4, 2000, application No. 60/250,967.

The following application gives the project non-dependent (or universal) systems notations and their respective definitions, estimation methods and a working example of how the process and method functions in a specific industry project type. The working example project type which is applied to the process and method detailed in this application is for the project types within The Records Imaging Acquisition, Processing, Data Migration to Workflow and Output Industry, as defined by the U.S. Dept. of Commerce Under the NAICS 514210, under Information Services. The apparatus is defined as the interface and embodiment of the research structure using the method and the process. The process is the research product or output values using the apparatus.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The field of endeavor that pertains to this invention is information technology projects planning, design, operations and management. This invention is a system that is used to solve for the relationships between empirical technical project requirements and dependent concepts, and core competencies of the users. The results of using the system is a three dimensional structure that depicts the solved relationships. There are no known documents which are related to my invention, and therefore no known problems with any prior art.

### BRIEF SUMMARY OF THE INVENTION

This invention is a system and method to calculate which specific data is required to be understood in order to conduct degrees of professional diligence, based upon the level of understanding that the user has. The invention generates a structure, by which, the data is ordered which enables an incremental path towards more complex data (degrees of subtlety) to be assimilated by the user. The data structure generated by the system results are three dimensional, which enables dependent concepts, degrees of subtlety and concept relationships to be visualized.

### BRIEF DESCRIPTION OF THE SEVERAL VIEWS OF THE DRAWINGS

The three drawings included with this application depict examples of the structural relationships that the system produces.

Drawing 1. shows the relationship between the array of available technologies (Atₙ values), types and corresponding ranges of subtleties between the array values and the area that defines the category of information that is based upon a task specificity, or (Ctₙ value). These are categories of information (data) based upon process task specificity, which is defined by the points a-i for the three Ctₙ values shown. The exact definitions for each Ctₙ value are given on page 6 and 7 of this application. Also depicted in Drawing 1. are juxtaposition (Jₙ values), which are perimeters in information categories that enclose areas that involve a high incidence of applied project knowledge. These terms are explained in detail on page 7 of this application.

Drawing 2. depicts the scale of knowledge required to conduct degrees of diligence using horizon generated nadir projections from Ctₙ values, their altitude is calculated from the threshold graduations for diligence based upon the Dtn′ values or mean threshold interface, given in detail on page 8 of the application.

Drawing 3. depicts the same information as Drawing 2, in addition to the Ctₙ value base plots in three dimensions, which are given in 2 dimensions in Drawing 1.

### DETAILED DESCRIPTION OF THE INVENTION

The process and method relates and solves for the values of system needs, or requirements, and business or government process needs or requirements, for a specific available technology or set of available technologies, given by:

Sₙ=Bp_{n and}, Bpₙ=Bprₙ+Rf . . .

Where,

Sₙ=System needs

Bpₙ=Business or Government process needs

Bprₙ=Business or Government process requirements (constrained by factors of resources, competency, business rules and, or compliancy)

Rf=the mean (σ) phase at which an available technology (given by, At) process is likely to occur in a given type of project

The project type system array of available technologies are expressed as Atₙ or available technology types. Degrees of subtlety within a specific available technology type is expressed as an approach range or →rngₙ

Abstracts and, or empirical content components, include project management tools; charts, diagrams and calculations. These Abstracts tend to span Atₙ boundaries. An example of how abstract values span Atₙ boundaries using the working example project type is how photomensuration or photometric calculations can be used for estimating all of the following:

1. Area and, or dimensions of formats and image characteristics

2. resolution at the capture, processing and output phases

3. data collection characteristics for quality determinations

Abstracts given by A, are related to Atₙ(s) in the following way:

A=Ctₙ+C+Bmps+Bprₙ

Where,

Ctₙ=The category of information (data) based upon process task specificity. The nth value is the proportion of competency, which is the value applied to the complexity or detail of information that the given abstract encompasses, as it relates to a process cycle that spans a particular category of information. C is expressed as the core competency value when project resources are estimated.

Bmps=Best management practices

Ctₙ values are not derived from Atₙ values themselves, but rather from the intersections of Atₙ values. For example, the project considerations for optical capture specifications at the phase of resolution in recognition and output and display are given as:

At₁rng₂+At₃rng₄+At₈rng₂=Ct₁₆

Ct₁₆ is plotted as points a+b+c in drawing 1.

and, Ct₁₇ is defined as the interpretive resolution at the phase of data entry verification and image database analysis, given as:

At₁→rng₂+At₄rng₃+At₁₃→rng₁₁=Ct₁₇

Ct₁₇ is plotted as points d+e+f in drawing 1.

The area of Ct₁₇ enclosed by Ct₁₆ encompasses the combinant relevant A value considerations for each of the Ctₙ values, viz., image processing through pattern recognition phases e.g., the interface along the length of points At₁→rng₂ and At₄→rng₃ enclosed by Ct₁₆ defines the juxtaposition of the value of J₈.

The points that define the length of (the interface) intersections describe the perimeters of the juxtapositions, or Jₙ values. The greatest length of intersection of Ctₙ areas is the base or b line segment of the Ctₙ, indicated by the length of ψ in Drawing 1. Jₙ values are perimeters in information categories that enclose areas that involve a high incidence of applied project knowledge. The areas that are enclosed by Jₙ values are expressed as juxtaposition areas of JAₙ area values.

The Jₙ defines areas or JAₙ values which are themselves requirements for Abstracts or Atₙ values. Jₙ values are integral to building cognitive and resource-mechanical advantages for conducting feasibility, risk assessments and diligence of projects that encompass the requisite range of Atₙ₍ₛ₎.

J₁₁ is defined by the interface along the length of points At₅→rng₅ and At_{7.4}→rng₆ enclosed by Ct₂₀.

Ct₂₀ is defined as image capture calibration at the phase of display for image database comparison and verification purposes, given as:

At₁→rng₆+At₈→rng₆+At₁₃>rng₃=Ct₂₀

Ct₂₀ is plotted as points g+h+i in drawing 1.

The set of Ctₙ values (Ct₁₆, Ct₁₇, Ct₂₀) are categories of information that occur primarily in the production phases of project processes and therefore, themselves share the same range order values, viz., 16-20.

Method for establishing the mean (σ) and threshold values for the scale of knowledge required to conduct degrees of diligence are calculated by:

$$\frac{Rf …}{2} - Rf = {Dt}_{n}^{n}$$

Where,

Dt=Diligence threshold

Rf=The estimation values for establishing the mean (σ) phase at which At processes are likely to occur in a given type of project, and therefore the mean level of probable adoption of the At as a dependent component in the project being modeled.

And Rf is calculated by:

$$\frac{R}{C} \cdot t \cdot Ad = Rf$$

Where,

Ad=Adoption weighting (general or average technology adoption rate) expressed as a percentage.

R=Resources weighting, excepting time, or t (within average resources) expressed as an integer value of 1-10, 1 being the least quantity of resources required.

C=Competency weighting (potential for concept to be applied) expressed as an integer value of 1-10, 1 being the least amount of competency required.

t=Time weighting (probable period between conception and operational relevancy to the project) expressed as an integer value of 1-10, 1 being the least amount of time required.

The diligence threshold range values for Ct_{16, 17 and 20} are expressed as:

Dtₙ¹⁻⁴

Where,

Dtⁿ=The range order value which establishes the altitude of the intersection of the zenith of a nadir projection of a Ctₙ along the horizon of the relative diligence scale or Z axis. The range order value or altitude is estimated by calculating:

$${Dt}^{n} or Δ = \frac{Rf \sum }{Ad \sum } \cdot SO$$

Where,

Δ=Level of competency required to apply the most elemental concepts of Ctₙ, calculated as an integer on a scale of 0-15, 0 being the least complexity required.

SO=subjective complexity level observation, expressed as an integer on a scale of 0-15, 0 being the least complexity involved with applying the Ctₙ concepts.

AdΣ=Adoption weighting sum of Ctₙ.

RfΣ=Sum of resource factors.

The Dtn′ or Δ range order values are calculated for Ct_{16, 17 and 20}, as follows:

$${Dt}^{n} or Δ = \frac{Rf \sum }{Ad \sum } \cdot SO$$

$$\begin{matrix} 1. {Dt}_{16}^{n} \\ n = \frac{8.3}{.8 + .7 + .9} \cdot 0 = 3.46 or 4 ∴ {Dt}_{16}^{n} = {Dt}_{16}^{4}\end{matrix}$$

$$\begin{matrix}\begin{matrix}2. {Dt}_{17}^{n} \\ n = \frac{10.5}{.8 + .9 + .65}\end{matrix} \cdot 0 = 4.47 or 5 ∴ {Dt}_{17}^{n} = {Dt}_{17}^{5} \\ 3. {Dt}_{20 \\}^{n} \\ n = \frac{7.3}{.55 + .7 + .8} \cdot 2.2 = 7.8 or 8 ∴ {Dt}_{20 }^{n} = {Dt}_{20}^{8}\end{matrix}$$

The scale of knowledge required to conduct degrees of diligence is relative to the altitude of the Ctₙ projection from nadir to its' respective zenith along the z axis scales' horizon, and is plotted relative to the range of Rfₙ values that are used to estimate the Diligence Threshold, or Dtₙ value for the Ctₙ. The resulting Dtₙ defines the mean value from which it is plotted along the length of altitude of a projection of Ctₙ (as plotted in drawing 2 and 3). The Dtₙ, or (σ) establishes the midpoint between the ranges of threshold graduations for diligence, given as:

Threshold I=The point at which any degree of diligence can be performed.

Threshold II=The point at which task-specific sets of operational diligence can be performed.

* The Dtn, or (σ) is the interface of Threshold II and III (shown on Drawing #2).

Threshold III=The point at which task specific sets of project planning diligence can be performed.

Threshold IV=The point at which design integrity testing diligence can be performed.

The Dtₙ for the Ctₙ is estimated by calculating:

$$Ctn = \frac{Rf1 + Rf2 + Rf3}{2} - Rf \sum = Dtn$$

The Ctₙ resource weighting factors Rfn are calculated for the range, as follows:

$$1. {Ct}_{16} = At1 -> rng2 + At3 -> rng4 + At8 -> rng2$$

$$\begin{matrix}a . At1 -> rng2 : \frac{R}{C} \cdot t \cdot Ad = Rf \\ or \\ \frac{5}{6} \cdot 7 ( .8 ) = 4.7 \\ {Rf}_{1} = 4.7 σ\end{matrix}$$

$$\begin{matrix}b . At3 -> rng4 : \frac{4}{5} \cdot 4 \cdot ( .7 ) = 2.2 \\ {Rf}_{2} = 2.2 σ\end{matrix}$$

$$\begin{matrix}c . At8 -> rng2 : \frac{3}{4} \cdot 2 \cdot ( .9 ) = 1.4 \\ {Rf}_{3} = 1.4 σ\end{matrix}$$

$$\begin{matrix}\frac{{Rf}_{1} + {Rf}_{2} + {Rf}_{3}}{2} - Rf \sum = {Dt}_{n} \\ \frac{4.7 + 2.2 + 1.4}{2} - 8.3 = {Dt}_{16} \\ or \\ - 4.2 σ\end{matrix}$$

$$2. {Ct}_{17} = At1 -> rng2 + At4 -> rng3 + At13 -> rng1$$

$$\begin{matrix}a . At1 -> rng2 : \frac{R}{C} \cdot t \cdot Ad = Rf \\ or \\ \frac{5}{6} \cdot 7 \cdot ( .8 ) = 4.7 \\ {Rf}_{1} = 4.7 σ \\ \begin{matrix}b . At4 \to rng3 : \frac{3}{4} \cdot 4 ( .9 ) = 2.7 \\ {Rf}_{2} = 2.7 σ \\ c . At13 \to rng11 : \frac{8}{10} \cdot 6 ( .65 ) = 3.1 \\ {Rf}_{3} = 3.1 σ\end{matrix}\end{matrix}$$

Ct₂₀=At₁→rng₆+At₈→rng₆+At₁₃→rng₃

$$3. {Ct}_{20} = {At}_{1} \to rng6 + At8 \to rng6 + At13 \to rng3$$

$$\begin{matrix}a . At1 -> rng6 : \frac{R}{C} \cdot t \cdot Ad = Rf \\ or \\ \frac{5}{7} \cdot 4 \cdot ( .55 ) = 1.6 \\ {Rf}_{1} = 1.6 σ\end{matrix}$$

$$\begin{matrix}b . At8 -> rng6 : \frac{4}{5} \cdot 3 ( .7 ) = 1.7 \\ {Rf}_{2} = 1.7 σ \\ c . At13 -> rng3 : \frac{5}{6} \cdot 6 ( .8 ) = 4 \\ {Rf}_{3} = 4 σ\end{matrix}$$

$$\begin{matrix}\frac{{Rf}_{1} + {Rf}_{2} + {Rf}_{3}}{2} - Rf \sum = {Dt}_{n} \\ \frac{1.6 + 1.7 + 4}{2} - 7.3 = {Dt}_{20} \\ or \\ - 3.7 σ\end{matrix}$$

The Dtn mean points represent the altitude above the Ctₙ base i.e., ascending from the totality of information, and discreetly cuts the Ctₙ projected solid forms to indicate the Area in which the other threshold graduations reside (pls. see pp. 10 and 11 of this application for the threshold graduation definitions).

1. What I claim as my invention is the system or estimation method that is described in the patent application which is used to document and solve for the relationships between:
a. technical project requirements
b. dependent concepts, and
c. core-competencies

2. I also claim as my invention the dimensional structure of the data that results from the system or estimation method described in the application and provided in the Drawings.
